(19) United States
(12) Patent Application Publication
(10) Pub. No.: US 2021/0175738 A1
(43) Pub. Date: Jun. 10, 2021

(54) Movable Wind Power Charging Device

(71) Applicant: Yu-Kun Hsieh, Tainan (TW)

(72) Inventor: Yu-Kun Hsieh, Tainan (TW)

(21) Appl. No.: 16/706,960

(22) Filed: Dec. 9, 2019

(51) Int. Cl. H02J 7/34; H02K 7/18; H02K 11/00; F03D 80/70; F03D 9/11

(52) U.S. Cl. CPC H02J 7/34; H02K 7/183; F03D 9/11; F03D 80/70; H02K 11/0094

(57) ABSTRACT

A movable wind power charging device includes a shaft, at least one stator secured on the shaft, a rotor rotatably mounted on the shaft and surrounding the at least one stator, and at least one impeller secured on the rotor. The at least one stator includes a plurality of stator coil windings. The rotor has a bearing mounted on the shaft, and has a plurality of magnets corresponding to the stator coil windings of the at least one stator. The movable wind power charging device is mounted on a transportation which includes a battery. An electric cord is connected between the at least one stator of the movable wind power charging device and the battery of the transportation.

### BACKGROUND OF THE INVENTION

### 1. Field of the Invention

The present invention relates to a charging device and, more particularly, to a movable wind power charging device.

### 2. Description of the Related Art

A conventional electric transportation comprises a battery to supply an electric power. The battery is charged previously so as to provide the required electric power to the electric transportation. However, the battery has a determined working time, thereby limiting the travel distance of the electric transportation. In addition, the battery is not easily charged outdoors, thereby causing inconvenience to the driver when needing to charge the battery at the outdoor place.

### BRIEF SUMMARY OF THE INVENTION

The primary objective of the present invention is to provide a movable wind power charging device that uses a wind power to charge an electric transportation successively during movement of the electric transportation.

In accordance with the present invention, there is provided a movable wind power charging device comprising a shaft, at least one stator secured on the shaft, a rotor rotatably mounted on the shaft and surrounding the at least one stator, and at least one impeller secured on the rotor. The at least one stator includes a plurality of stator coil windings. The at least one stator has a center provided with a hole allowing passage of the shaft. The rotor has a center provided with a bearing mounted on the shaft. The rotor has an interior having a periphery provided with a plurality of magnets corresponding to the stator coil windings of the at least one stator. The shaft extends through the hole of the at least one stator. The rotor is mounted on the shaft and covers the at least one stator, with the bearing of the rotor being locked onto the shaft. The movable wind power charging device is mounted on a transportation which includes a battery. An electric cord is connected between the at least one stator of the movable wind power charging device and the battery of the transportation.

According to the primary advantage of the present invention, the movable wind power charging device transforms the wind power into an electric energy, to achieve an environmental protection function by a green energy.

According to another advantage of the present invention, the movable wind power charging device charges the battery of the electric transportation successively during movement of the electric transportation, so as to increase the working time of the battery.

According to a further advantage of the present invention, the movable wind power charging device directly charges the battery outdoors, thereby facilitating the driver charging the electric transportation.

According to a further advantage of the present invention, the electric transportation is charged during movement without being affected by the weather condition.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a movable wind power charging device in accordance with the first preferred embodiment of the present invention.

FIG. 2 is a perspective view of the movable wind power charging device in accordance with the preferred embodiment of the present invention.

FIG. 3 is a perspective view showing the movable wind power charging device for a first transportation.

FIG. 4 is a perspective view of a movable wind power charging device having a wind collecting cover.

FIG. 5 is a perspective view showing the movable wind power charging device for a second transportation.

FIG. 6 is a perspective view of a movable wind power charging device having a wind collecting cover.

FIG. 7 is a perspective view of a movable wind power charging device in accordance with the second preferred embodiment of the present invention.

FIG. 8 is an exploded perspective view of a movable wind power charging device in accordance with the third preferred embodiment of the present invention.

FIG. 9 is a perspective assembly view of the movable wind power charging device as shown in FIG. 8.

FIG. 10 is a perspective view showing the movable wind power charging device for the first transportation.

FIG. 11 is a perspective view showing the movable wind power charging device for a third transportation.

### DETAILED DESCRIPTION OF THE INVENTION

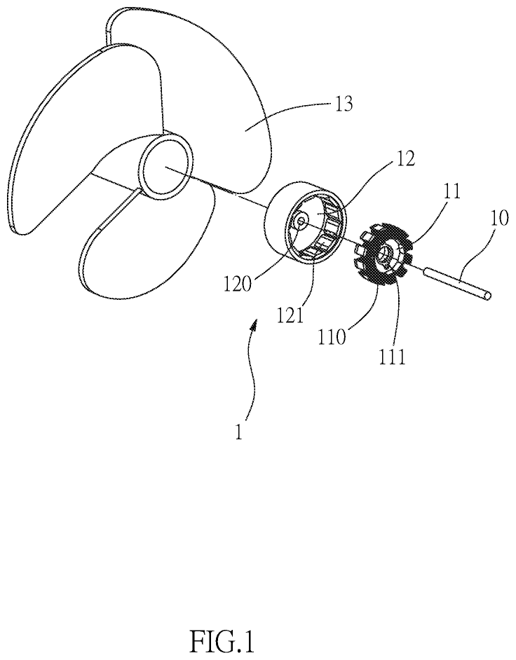

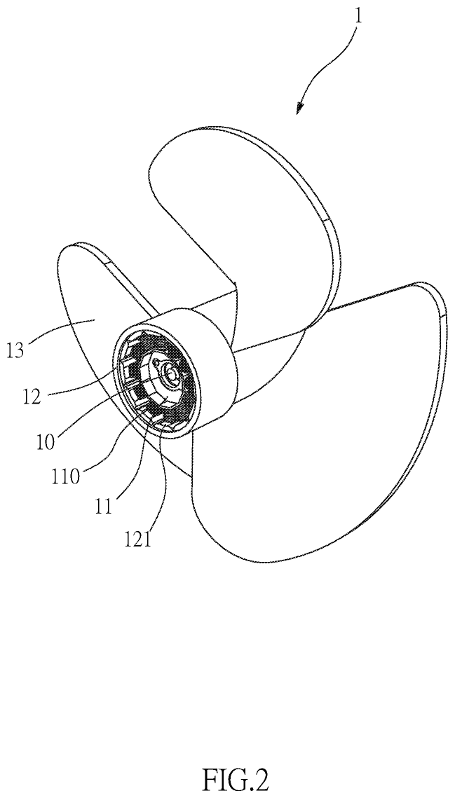

Referring to the drawings and initially to FIGS. 1 and 2, a movable wind power charging device 1 in accordance with the preferred embodiment of the present invention comprises a shaft 10, at least one stator (magnetic unit) 11 secured on the shaft 10, a rotor (or rotary disk) 12 rotatably mounted on the shaft 10 and surrounding the at least one stator 11, and at least one impeller 13 secured on the rotor 12.

The at least one stator 11 is disposed in the rotor 12 and includes a plurality of stator coil windings (or stator windings or magnetic coils) 110. The at least one stator 11 has a center provided with a hole 111 allowing passage of the shaft 10. The rotor 12 has a center provided with a bearing 120 mounted on the shaft 10. The rotor 12 has an interior having a periphery provided with a plurality of magnets (or magnetic blocks) 121 corresponding to the stator coil windings 110 of the at least one stator 11. The at least one impeller 13 is a common impeller.

In assembly, the at least one impeller 13 is initially secured on the rotor 12. The shaft 10 extends through the hole 111 of the at least one stator 11. Then, the rotor 12 is mounted on the shaft 10 and covers the at least one stator 11, with the bearing 120 of the rotor 12 being locked onto the shaft 10. Thus, the movable wind power charging device 1 is assembled.

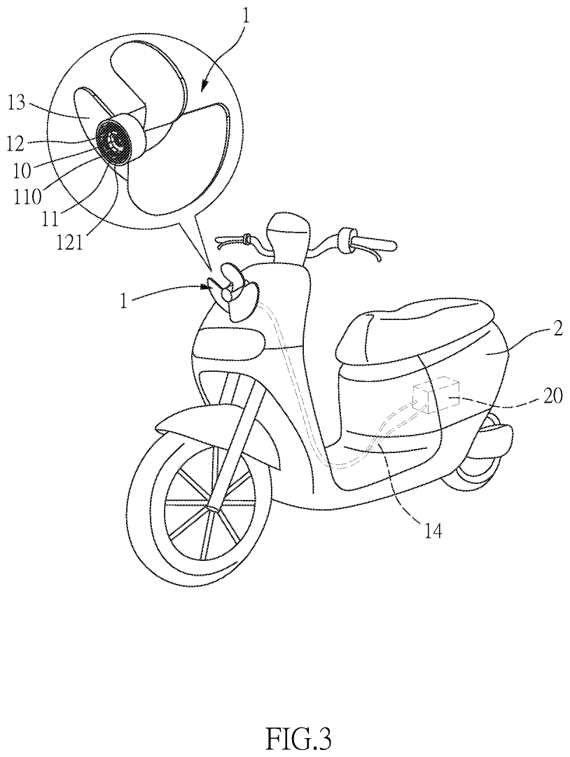

In operation, referring to FIG. 3 with reference to FIGS. 1 and 2, the movable wind power charging device 1 is mounted on a transportation (or transit or vehicle) 2 which includes a battery 20. An electric cord 14 is connected between the at least one stator 11 of the movable wind power charging device 1 and the battery 20 of the transportation 2. Preferably, the transportation 2 is an electric motorcycle. In such a manner, when a wind power is applied to the at least one impeller 13, the at least one impeller 13 is driven and rotated by the wind power, such that the rotor 12 is driven by the at least one impeller 13 to rotate relative to the at least one stator 11. When the rotor 12 is rotated relative to the at least one stator 11, the magnets 121 of the rotor 12 are moved relative to the stator coil windings 110 of the at least one stator 11, to perform a magnetic interaction, so as to produce a magnetic field having a magnetic force which is transformed into an electric current or power by a magnetic conversion. Then, the electric power generated by rotation of the at least one impeller 13 is delivered through the electric cord 14 to the battery 20 of the transportation 2, and is stored in the battery 20. Thus, the battery 20 is charged during movement of the transportation 2. In addition, when the speed of the transportation 2 is increased, the rotation speed of the at least one impeller 13 is increased, such that the generating quantity of electricity is increased, thereby shortening the time for charging the battery 20 of the transportation 2.

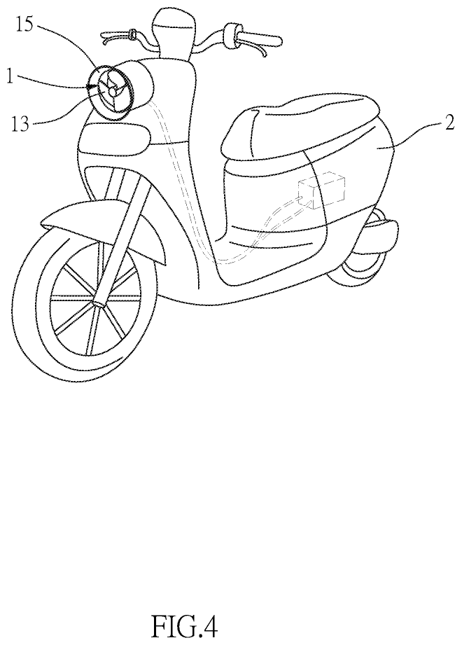

Referring to FIG. 4 with reference to FIGS. 1 and 2, a wind collecting cover (or hood) 15 is located at a front end of the movable wind power charging device 1, to collect and concentrate the wind power, so as to increase the rotation speed of the at least one impeller 13. The wind collecting cover 15 has an opening extending through a whole length of the wind collecting cover 15. The wind collecting cover 15 has a dimension that is decreased gradually from front to back, to increase a wind facing area, and to focus the wind power, such that the at least one impeller 13 is revolved rapidly, so as to enhance the generating quantity.

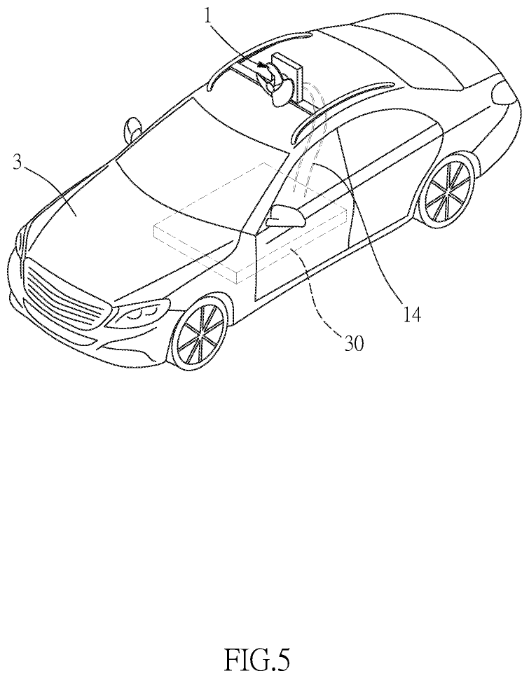

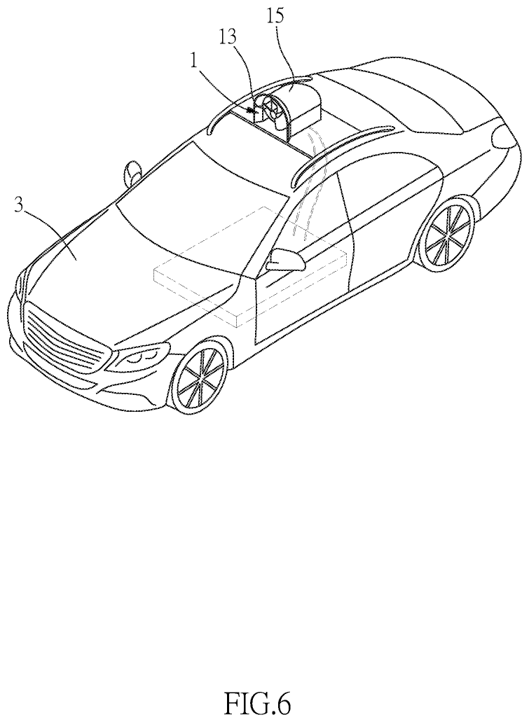

Referring to FIGS. 5 and 6 with reference to FIGS. 1 and 2, the transportation is an electric car 3 which includes a battery 30. The electric cord 14 is connected between the at least one stator 11 of the movable wind power charging device 1 and the battery 30 of the electric car 3.

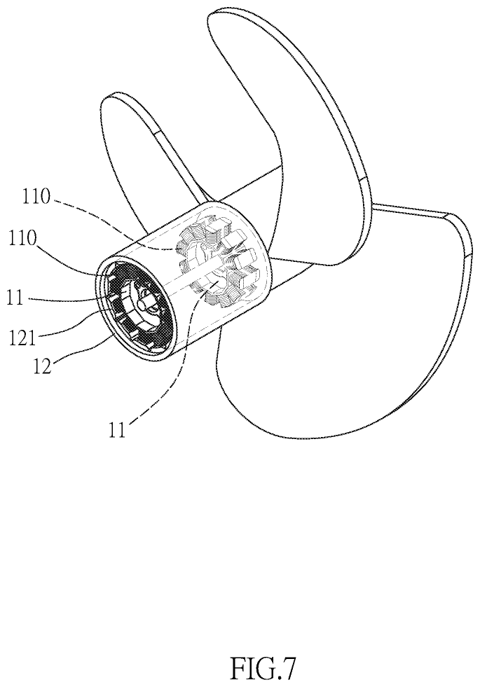

Referring to FIG. 7 with reference to FIGS. 1 and 2, the movable wind power charging device comprises a plurality of, preferably two, stators 11 mounted in and covered by the rotor 12. Thus, the two stators 11 cooperate with the rotor 12 to produce a larger magnetic field, and to generate a larger electric power, so as to increase the generating quantity.

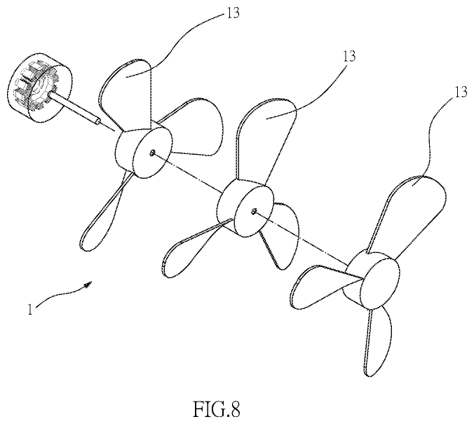

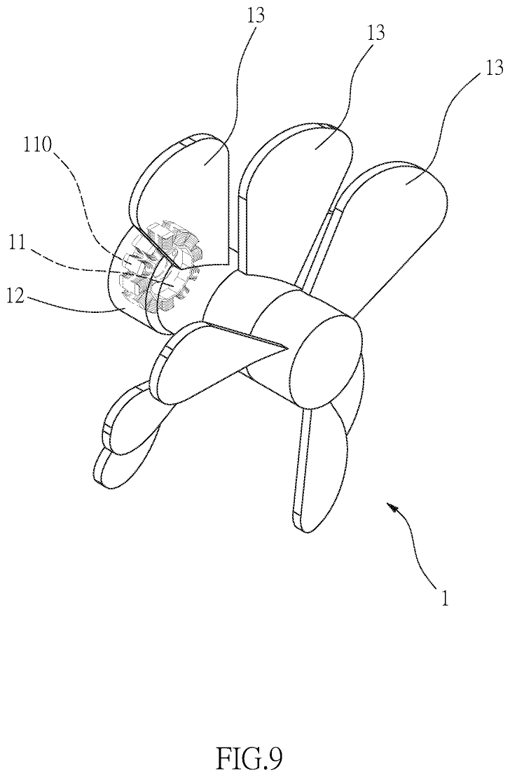

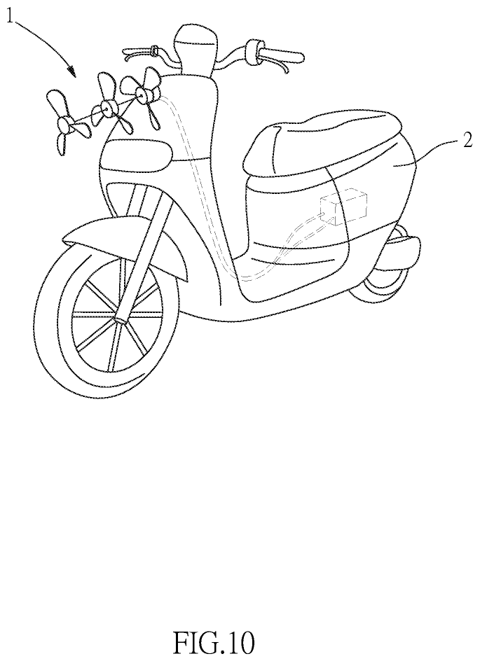

Referring to FIGS. 8-10 with reference to FIGS. 1 and 2, the movable wind power charging device 1 comprises a plurality of impellers 13 which are combined and assembled together. In such a manner, the impellers 13 are rotated synchronously, to accelerate rotation of the rotor 12. Thus, the impellers 13 increase a wind facing area, such that the rotation speed is increased, so as to enhance the generating quantity.

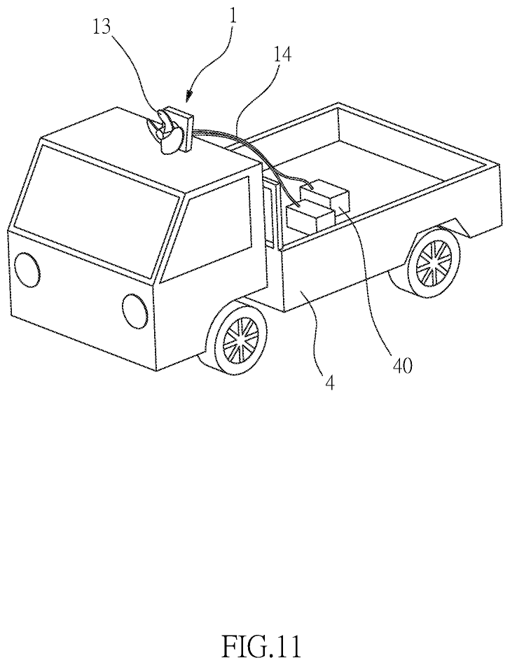

Referring to FIG. 11 with reference to FIGS. 1 and 2, the transportation is a petrol (or gasoline) car 4 which includes a battery 40. The electric cord 14 is connected between the at least one stator 11 of the movable wind power charging device 1 and the battery 40 of the petrol car 4. Thus, the battery 40 of the petrol car 4 is charged by the movable wind power charging device 1. After the electric power of the battery 40 is full, the battery 40 is taken out and used for other purpose.

Accordingly, the movable wind power charging device 1 transforms the wind power into an electric energy, to achieve an environmental protection function by a green energy. In addition, the movable wind power charging device 1 charges the battery of the electric transportation successively during movement of the electric transportation, so as to increase the working time of the battery. Further, the movable wind power charging device 1 directly charges the battery outdoors, thereby facilitating the driver charging the electric transportation. Further, the electric transportation is charged during movement without being affected by the weather condition.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A movable wind power charging device comprising:
a shaft;
at least one stator secured on the shaft;
a rotor rotatably mounted on the shaft and surrounding the at least one stator; and
at least one impeller secured on the rotor;
wherein:
the at least one stator includes a plurality of stator coil windings;
the at least one stator has a center provided with a hole allowing passage of the shaft;
the rotor has a center provided with a bearing mounted on the shaft;
the rotor has an interior having a periphery provided with a plurality of magnets corresponding to the stator coil windings of the at least one stator;
the shaft extends through the hole of the at least one stator;
the rotor is mounted on the shaft and covers the at least one stator, with the bearing of the rotor being locked onto the shaft;
the movable wind power charging device is mounted on a transportation which includes a battery; and
an electric cord is connected between the at least one stator of the movable wind power charging device and the battery of the transportation.

2. The movable wind power charging device of claim 1, wherein a wind collecting cover is located at a front end of the movable wind power charging device.

3. The movable wind power charging device of claim 1, wherein the at least one impeller is a common impeller.

4. The movable wind power charging device of claim 1, wherein the movable wind power charging device comprises a plurality of impellers which are combined and assembled together.
